(19) United States
(12) Patent Application Publication
(10) Pub. No.: US 2005/0099560 A1
(43) Pub. Date: May 12, 2005

(54) Reflective type liquid crystal display device and manufacture method thereof

(76) Inventors: Koji Suzuki, Haguri-gun (JP); Kazuto Noritake, Gifu-shi (JP)

Correspondence Address: CANTOR COLBURN, LLP, 55 GRIFFIN ROAD SOUTH, BLOOMFIELD, CT, 06002, US

(21) Appl. No.: 11/008,030

(22) Filed: Dec. 9, 2004

Related U.S. Application Data
(63) Continuation of application No. 09/364,159, filed on Jul. 30, 1999.

(30) Foreign Application Priority Data
Jul. 31, 1998 (JP) HEI 10-218192

(51) Int. Cl. G02F 1/1335

(52) U.S. Cl. 349/113

(57) ABSTRACT

An active layer (14) which has a gate electrode (11), a gate insulating film (12), a source (14s) and a drain (14d) is formed on an insulating substrate (10), so that a thin film transistor is formed. On this, an inter-layer insulating film (15) and a flattening insulating film (17) are laminated. Subsequently, after a contact hole is formed in the inter-layer insulating film (15) and the flattening insulating film (17), a back-surface electrode (41) constituted of molybdenum or another high melting point metal is formed, on which a display electrode (18) constituted of aluminum is formed. The presence of the back-surface electrode (41) prevents protrusions from being generated on the display electrode (18).

### BACKGROUND OF THE INVENTION

1. Field of the Invention

The present invention relates to a reflective type liquid crystal display device provided with a display electrode made of a reflective material.

2. Description of the Related Art

A reflective type liquid crystal display device has been proposed wherein a display is observed by light reflected incident from the observation direction.

FIG. 2 shows a sectional view of such a conventional reflective type liquid crystal display device.

As shown in FIG. 2, the conventional reflective type liquid crystal display device comprises an insulating substrate 10 having a thin film transistor (hereinafter referred to as TFT) or another switching element, an aluminum (Al) display electrode 18 connected to the TFT, and an orientation film 22a for covering these components formed thereon, and an opposite electrode substrate 20 having an opposite electrode 21, and an orientation film 22b for covering the electrode 21 formed thereon. The substrates oppose each other across a void; the orientation films 22a, 22b are bonded together by an adhesive seal agent 23; and the void is filled with a liquid crystal material such as twisted nematic liquid crystal (TN liquid crystal) 30. Moreover, a polarization plate 24 is provided on the side of an observer 100 outside the liquid crystal display device.

Natural light 40 from the outside is incident upon the polarization plate 24 on the side of the observer 100. The light is transmitted through the opposite electrode substrate 20, the opposite electrode 21, the orientation film 22b, the TN liquid crystal 30, and the orientation film 22a on the TFT substrate 10, and then reflected by the display electrode 18, transmitted through the layers in a direction reverse to the incident direction, and emitted via the polarization plate 24 on the opposite electrode substrate 20 to enter the observer's eyes 100.

However, since the aforementioned display electrode is formed by depositing and patterning Al by a sputtering process, protrusions are generated on a display electrode surface during the formation by sputtering. Protrusions are also generated on the display electrode surface by heat treatment after the sputtering. Therefore, drawbacks result in that a mirror-surface reflectance is lowered and that a bright display on which external light is sufficiently reflected cannot be obtained.

### SUMMARY OF THE INVENTION

In the present invention, a back-surface electrode is formed on a back surface of a display electrode in a reflective type liquid crystal display device. Because protrusions cannot easily form on the surface of the display electrode due to the presence of the back-surface electrode, the mirror-surface reflectance of the display electrode is enhanced, and a brighter display can be obtained.

Molybdenum, titanium, or another high melting point metal are especially preferable for the back-surface electrode.

### BRIEF DESCRIPTION OF THE DRAWINGS

FIG. 1 is a sectional view of one display pixel section of a reflective type liquid crystal display device according to the present invention.

FIG. 2 is a schematic sectional view of a conventional reflective type liquid crystal display device.

### DESCRIPTION OF THE PREFERRED EMBODIMENT

A reflective type liquid crystal display device according to the present invention will be described hereinafter.

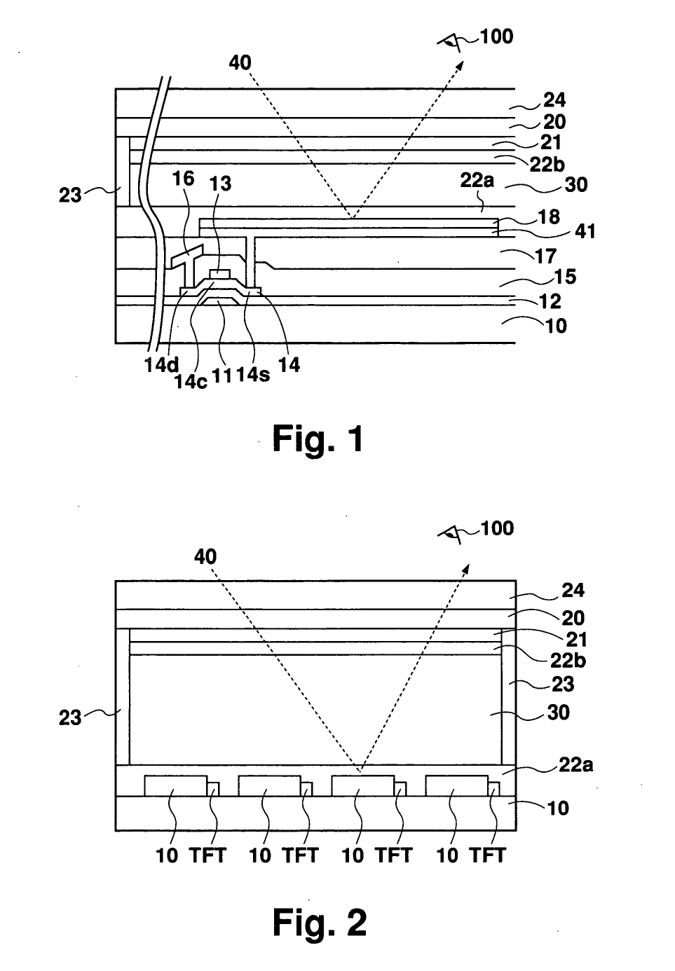

FIG. 1 shows a sectional view of one display pixel of the reflective type liquid crystal display device of the present invention.

As shown in FIG. 1, a gate electrode 11 formed of Cr or another metal is formed on glass or another insulating substrate 10, and an active layer 14 constituted of polycrystalline silicon is formed via a gate insulating film 12 constituted of SiO₂ or another insulating film provided on the gate electrode 11. A stopper 13 made of SiO₂ or another insulating film is formed on the active layer 14 and, using the stopper 13 as a mask, impurities are injected to the active layer 14 to form a source 14s and a drain 14d. A portion masked by the stopper 13 forms a channel 14c. An inter-layer insulating film 15 is formed on the stopper 13, the active layer 14 and the gate insulating film 12. A contact hole is formed at a position corresponding to the drain 14d of the inter-layer insulating film 15 and a drain electrode 16 is connected through this hole.

A flattening insulating film 17 is then formed on the inter-layer insulating film 15 and the drain electrode 16, and a contact hole is formed in a position corresponding to the source 14s in the inter-layer insulating film 15 and the flattening insulating film 17.

Approximately 1000 angstroms of molybdenum (Mo) is deposited in the contact hole and on the flattening insulating film 17 by a sputtering process, and thereupon approximately 2000 angstroms of Al is similarly deposited by the sputtering process. Thereafter, a resist pattern for forming a display electrode 18 is formed on the Al, and the Al and Mo are etched in sequence, so that the display electrode 18 constituted of Al, and a back-surface electrode 41 having the same shape as the display electrode 18 and constituted of Mo is formed. In this case, a part of the back-surface electrode 41 is extended to the source 14s via the contact hole formed in the position corresponding to the source 14s of the flattening insulating film 17 and the inter-layer insulating film 15. The back-surface electrode 41 also abuts the back surface of the surface electrode 18 by its entire surface. Therefore, the display electrode 18 also functions as a source electrode. The insulating substrate 10 with TFT formed thereon, i.e., the TFT substrate 10, is completed in this manner.

As shown by the dotted line in FIG. 1, natural light 40 transmitted from the outside follows a course wherein it strikes a polarization plate 24 from the side of an observer 100; is transmitted through an opposite electrode substrate 20, an opposite electrode 21, an orientation film 22b, a liquid crystal 30, and an orientation film 22a on the TFT substrate 10; and is then reflected by the display electrode 18 made of Al. The light is subsequently transmitted through the layers in a direction reverse to the incident direction and emitted via the polarization plate 24 of the opposite electrode substrate 20 towards the observer's eyes 100.

When the back-surface electrode 41 of a high melting point metal is provided on the back surface of the display electrode 18, the crystal grain diameter of the Al is reduced. As a result, stresses are suppressed and bumps do not easily generated on the surface.

In addition to Mo and titanium (Ti), tungsten (W), tantalum (Ta), chromium (Cr), other high melting point metals, and alloys of the metals such as MoW and TiW can be used as the material of the back-surface electrode 41. Furthermore, Ti is of a hexagonal system. When Ti is used, it is well compatible with Al of a centroid cubic system in respect of a crystal lattice structure. Since Al is formed on a crystal surface which is easily placed in (111) orientation state, protrusions or bumps do not easily generate on the surface.

Moreover, a twisted nematic liquid crystal (TN liquid crystal) having a birefringence control mode and using a polarization plate can be used as the liquid crystal material.

As described above, when Mo, Ti, or another high melting point metal is formed in the same shape as the display electrode on the back surface of the display electrode 18, and the display electrode 18 is sputtered/formed, protrusions are not easily generated on the surface even during subsequent heat treatment. Moreover, the mirror-surface reflectance of the display electrode made of Al is not lowered, and a reflective type liquid crystal display device realizing a bright display can be obtained.

Furthermore, a thickness of the back-surface electrode 41 may be in the range of 200 to 1500 angstroms to such a degree that no protrusions are generated on the display electrode 18.

Moreover, while the use of a so-called bottom gate type TFT with TFT gate electrode formed under the active layer in the reflective type liquid crystal display device has been described, similar effects are obtained when the present invention is applied to a reflective type liquid crystal display device provided with a top gate type TFT in which the gate electrode is formed on the active layer.

With the liquid crystal display device of the present invention, there can be provided a reflective type liquid crystal display device in which protrusions or bumps are not easily generated on the display electrode surface, the mirror-surface reflectance is enhanced, and a bright display is obtained.

1. A reflective type liquid crystal display device on which display is created by reflecting light incident from the display observation side, comprising:
a display electrode made of a reflective material for reflecting the incident light on a surface thereof;
a back-surface electrode disposed in contact with a back surface of the display electrode; and
a transistor for controlling current to the display electrode, said back-surface electrode and the transistor being electrically interconnected,
wherein said transistor is a thin-film transistor which has an active layer, and a portion of the back-surface electrode is directly connected to said active layer via a contact hole,
wherein said display electrode and said back-surface electrode are patterned into the same shape,
wherein said back-surface electrode is made of a high melting point metal, and
a thickness of said back-surface electrode is such that no substantial protrusion is formed in said display electrode and said thickness of said back-surface electrode is greater than 200 Å and less than or equal to 1500 Å.

2. The device according to claim 1, wherein said active layer is a polycrystalline silicon layer.

3. A method of manufacturing a reflective type liquid crystal display device on which display is created by reflecting light incident from the display observation side, comprising:
a step of forming a back-surface electrode layer, a thickness of said back-surface electrode layer is such that no substantial protrusion is formed in said display electrode and said thickness of said back-surface electrode is greater than 200 Å and less than or equal to 1500 Å and wherein said back-surface electrode is made of a high melting point metal;
a step of forming a display electrode layer constituted of a reflective material on the back-surface electrode layer; and
a step of patterning the formed back-surface electrode layer and the display electrode layer to form a surface electrode and a back-surface electrode in the same shape,
to form a display electrode for reflecting the incident light by a surface thereof and the back-surface electrode disposed in contact with a back surface of the display electrode.

4. The method according to claim 2, further comprising:
a process of forming a thin film transistor as an active layer of polycrystalline silicon on a substrate;
a step of forming an insulating film to cover the thin film transistor; and
a step of forming a contact hole in the insulating film, wherein
said back-surface electrode is formed on a smoothened film with said contact hole formed therein.

5. A method of manufacturing a reflective type liquid crystal display device on which display is created by reflecting light incident from the display observation side comprising:
a step of forming a back-surface electrode layer;
a step of forming a display electrode layer constituted of a reflective material on the back-surface electrode layer;
a step of patterning the formed back-surface electrode layer and the display electrode layer to form a surface electrode and a back-surface electrode in the same shape;
to form a display electrode for reflecting the incident light by a surface thereof and the back-surface electrode disposed in contact with a back surface of the display electrode;
a process of forming a thin film transistor as an active layer of polycrystalline silicon on a substrate;
a step of forming an insulating film to cover the thin film transistor; and
a step of forming a contact hole in the insulating film, wherein
said back-surface electrode is formed on a smoothened film with said contact hole formed therein, wherein
said back-surface electrode layer is made of a high melting point metal, wherein
a thickness of said back-surface electrode layer is greater than 200 Å and less than or equal to 1500 Å.

6. The method according to claim 5, wherein
said high melting point metal is selected from the group consisting of molybdenum, titanium, tungsten, tantalum and chromium, or an alloy thereof.

7. A reflective type liquid crystal display device on which display is created by reflecting light incident from the display observation side, comprising:
a display electrode made of a reflective material for reflecting the incident light on a surface thereof;
a back-surface electrode disposed in contact with a back surface of the display electrode; and
a transistor for controlling current to the display electrode, said back-surface electrode and the transistor being electrically interconnected,
wherein said transistor is a thin-film transistor which has an active layer, and a portion of the back-surface electrode is directly connected to said active layer via a contact hole,
wherein said display electrode and said back-surface electrode are patterned into the same shape, and
a thickness of said back-surface electrode is such that no substantial protrusion is formed in said display electrode,
said back-surface electrode is made of a high melting point metal, said display electrode is made of aluminum, and said display electrode is in (111) orientation state, and
said thickness of said back-surface electrode is greater than 200 Å and less than or equal to 1500 Å.

8. The device according to claim 7, wherein said active layer is a polycrystalline silicon layer.

9. The device according to claim 7, wherein a part of the back-surface electrode elongates to a place above a part of the active layer and the contact hole is formed between the one end portion of the back-surface electrode and the part of the active layer.

10. A method of manufacturing a reflective type liquid crystal display device on which display is created by reflecting light incident from the display observation side, comprising:
a step of forming a back-surface electrode layer, a thickness of said back-surface electrode layer is such that no substantial protrusion is formed in said display electrode, said back-surface electrode layer is made of a high metal point metal;
a step of forming a display electrode layer constituted of a reflective material on the back-surface electrode layer, said display electrode layer is made of aluminum, said display electrode layer is in (111) orientation state; and
a step of patterning the formed back-surface electrode layer and the display electrode layer to form a surface electrode and a back-surface electrode in the same shape,
to form a display electrode for reflecting the incident light by a surface thereof and the back-surface electrode disposed in contact with a back surface of the display electrode,
wherein a thickness of said back-surface electrode layer is greater than 200 Å and less than or equal to 1500 Å.

11. The method according to claim 10, further comprising:
a process of forming a thin film transistor as an active layer of polycrystalline silicon on a substrate;
a step of forming an insulating film to cover the thin film transistor; and
a step of forming a contact hole in the insulating film, wherein
said back-surface electrode is formed on a smoothened film with said contact hole formed therein.

12. A reflective type liquid crystal display device comprising:
a back-surface electrode layer;
a display electrode layer is constituted of a reflective material on the back-surface electrode layer;
a back-surface electrode layer and the display electrode layer are patterened to form a surface electrode and a back-surface electrode in the same shape;
a display electrode for reflecting the incident light by a surface thereof and the back-surface electrode disposed in contact with a back surface of the display electrode;
a thin film transistor is formed as an active layer of polycrystalline silicon on a substrate;
an insulating layer is formed to cover the thin film transistor; and
a contact hole is formed in the insulating film, wherein
said back-surface electrode is formed on a smoothened film with said contact hole formed therein, and
said back-surface electrode is made of a high melting point metal, said display electrode is made of aluminum, and said display electrode is in (111) orientation state,
wherein a thickness of said back-surface electrode is greater than 200 Å and less than or equal to 1500 Å.
